(19) United States
(12) Patent Application Publication
(10) Pub. No.: US 2002/0048037 A1
(43) Pub. Date: Apr. 25, 2002

(54) Method and system for the collection of uniquely individualized data and the ordering, display and printing of individualized items via a communications network

(76) Inventor: Anthony Kevin Carbone, Bluemont, VA (US)

Correspondence Address: ANTHONY K. CARBONE, 17534 RAVEN ROCKS ROAD, BLUEMONT, VA, 20135, US

(21) Appl. No.: 09/981,815

(22) Filed: Oct. 19, 2001

Related U.S. Application Data
(60) Provisional application No. 60/242,663, filed on Oct. 24, 2000.

(51) Int. Cl. G06F 15/00; B41F 1/00

(52) U.S. Cl. 358/1.14

(57) ABSTRACT

A method and system for the collection of unique and individualized data, herein called content, via the Internet and storing that content. The method and system also provides for the ordering, display and printing of that content itself or in combination with other data which may be less unique but still individualized to produce a multiplicity of items each of which retains a unique character. This is in contrast to any conventional system that provides for the printing of personalized items, while unique to the order, are not individually unique but instead are identical replicas. The system is comprised of a client system operated by the user and a server system which supplies forms to the client system to collect the content, forms to edit the content, forms and methods to combine or manipulate the content with other content, and methods for the user to preview the content or combined content and to print the content on printable items either at the physical location of either the server system or the client system.

### CROSS REFERENCE TO RELATED APPLICATIONS

This application is entitled to the benefit of Provisional Patent Application Ser. No. 60/242,663 filed on Oct. 24, 2000.

Cross-references to other related patent applications may be made when appropriate.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

The present invention relates to a computer controlled method and system for the collection of uniquely different content and printing that content on identical or uniquely different items and, more particularly, to a method and system for printing uniquely different content over the Internet using any device capable of adhering to Internet operability specifications. This invention improves existing personalization methods with the addition of individualization methods. This invention requires interoperability with printing devices that permit the successive outputting of uniquely different content. Such devices include, but are not limited to, laser and ink-jet printers. Other printing devices such as conventional printing presses that use fixed plates are not suitable.

I. Background Of Personalized Versus Individualized Printing

It is important to clarify the difference or confused use between “personalization” and “individualization.” Consider the American Heritage Dictionary's definition for each: “personalize-3. To have printed, engraved, or monogrammed with one's name or initials: personalized stationery” and “individualize-, 2. To form into a separate and distinct entity.” Thus, this invention recognizes that the term “personalize”, in common marketing practice by the personalization industry is not identical to “individualize.”

To further clarify the difference between personalization and individualization, personalizing in the printing industry means that the user supplies one or more datum each of which is unique but is printed in combination and replicated identically on each printed item. Individualization, as described by this invention, is applied to the user who supplies a multiplicity of data where each datum is unique and desires the printing of unique distinct and separate items comprising one order.

This invention uses the phrase “uniquely individualized” to clearly differentiate it from ordinary “personalized” printing since the word personalized appears in numerous patents relating to printing. A user can order 500 business cards whose content is specified by the user. Each card is printed identically and the indicia printed on the cards is personalized. On the other hand, the subject of this invention provides for a user specifying text or graphics that are fixed (printed on each product) along with user supplied text or graphics that will vary uniquely with each subsequently printed product. (Needless to say that “serial numbering” the printed product is not relevant even though each printed product would then be uniquely individualized. This is so since serial numbering is a form of automatic indexing and is not user-supplied data.) A business card conforming to this method would include the additional fixed text of “This card has been specifically printed for [SOMENAME].” [SOMENAME] then would be found in a database of 500 intended recipient's names. This could be called the individualization database while the fixed information on the card would be in the personalization database. When these cards are printed, each card is uniquely individualized using the content of both databases. Furthermore, this invention provides for an “intelligent” combination of the fixed and variable data. Consider “This card has been specifically printed for [[Mr./Mrs.]] [SOMENAME].” This invention includes a method of examining the variable [SOMENAME] and making possible changes to the fixed text dependent variable [[Mr./Mrs.]]. One way to do this is to have another database of male names and female names. Before printing [SOMENAME], it is examined for sex and a choice of Mr. or Mrs. is adjusted in the fixed text accordingly. Another example of grammar modification, singular vs. plural, is included in the invention.

Modem printing presses use plates most often produced from a photographic process using either film or plastic materials that are created by imagesetters driven by computers. This is an extremely expensive and time-consuming process of and by itself. Often the process is chemical based and requires expensive hazardous waste material handling and disposal.

The personalization printing industry uses this technology to produce plates that are personalized to the needs of a customer but all printed product is identical. When the target print item is paper, these presses can not only produce ink on paper or flat printing, but can embellish the product to produce raised-ink (thermography) or even use the engraving process. Current print device technologies such as laser or ink-jet imprinting does not yet have the ability to replicate the aforementioned print features of plate based printing presses but have the advantage of variable output. This invention is not restricted to currently available print devices but has the ability to operate with new or future technology.

The process of creating a printed page is called page composition. It does not matter whether the target output device is a printing press or an ink-jet printer. Page composition is usually made with computers and a graphical display showing an exact replica of the final print on a computer screen. Throughout the personalization printing industry, the page composition process utilizes data stored in a database. This invention extends the scope of the database so that additional layers of database storage are used. Thus, the database would contain the basic information about an order such as the customer name and address, item to be printed, and so on. But the database would also include features to store the variable data, meaning that data which is unique and individualized for each item to be printed.

Several software products currently exist that provide for individualized printing. But these products require that the database, data entry mechanism, and print device be utilized on the same computer. These products are thus, stand-alone software applications without Internet interoperability.

II. Background Of The Internet

The Internet consists of a plethora of computers and computer networks all interconnected using various communication links. These can be wired, radio frequency, by any means, or even optical. The Internet relies on certain communication standards and certain formatting or display standards that allow the data or information to be manipulated and displayed in a consistent manner.

Specifically, the World Wide Web (“WWW”) uses a server component or computer to send information, typically called “Web Pages” to another component called a client. These pages can be static meaning that they are stored on the server component and never change or can be dynamic and can change based on some criteria. The client, usually another computer, displays those pages sent by the server. The client computer uses a software component called a browser. One function of the browser is to accept the pages of information, interpret the content in a prescribed manner and display the information. Another function of the browser is to initiate activity using data that can be entered into the browser and/or with buttons or other features contained on the page to cause the server computer to perform some desired action. One example of this is that the server component can accept data entered onto a displayed page by the browser on the client component and record this data into a database located on the server component when a button on the displayed page is pressed.

The format of Web Pages can be defined using HyperText Markup Language (“HTML”). These are standards that define how a Web Page is to be displayed. This HTML can also contain any number of “scripting languages” which, when combined with software that also exists on the client computer, can be used to extend the functionality of the client and server relationship. A script might write to a file contained on the client computer as contrasted with the simple displaying of information on the client computer's screen. This file could be used, for example, to identify the client the next time the client connects to the server without requiring the client to reenter a multiplicity of information. This file is often called a “cookie.” Such features and functions are well known to those skilled in the art.

One use of the World Wide Web is to provide resources to clients who lack certain facilities. For example, a client can search a database containing billions of pieces of information that could not be contained on the client computer due to excessive cost, storage requirements, or other missing resources. Another, but more relevant example is given by the client who needs their name printed on a golf ball but who neither possesses the software, the golf ball, or the complex and expensive printing apparatus. Thus, the World Wide Web provides immediate access to often expensive or complex resources.

Personalization is also featured in another context wherein it is common practice to permit a user to personalize or customize their ‘home page’ on various web sites. This simply means that the user can select from a variety of prescribed elements of content (viz., combining selected stock market items, a newspaper, and area specific weather reports, or even television listings), such that the user, upon visiting that web site is presented with a home page whose layout and content they assigned. There also exist web sites that will display and print or mail newsletters whose content is similarly selected. This invention does not relate in any manner to the selection of commonly available data or content (viz., a newspaper clipping service). This invention specifically calls for the unique and individualized data supplied by the user to be made part of the final printed product.

Existing printing companies have embraced the Internet for personalized printing. However, they have simply translated their current order taking methods and applied them to the Internet. This invention extends that process significantly since it adds the ability to order uniquely individualized product.

### BRIEF SUMMARY OF THE INVENTION

An embodiment of the present invention provides a method and system for printing unique and individualized items from the data entered on and sent by a client system to a printing device on a server system or a client system wherein the database resides on the server system. The client system is provided with an identifier that identifies a customer. The server system creates and opens a database for the identified customer. The client system displays a form for the data entry of the personalization and individualization information. The client system also displays one or more forms that may include a selection of other variable data maintained on the server system. The variable data includes various levels of personalization and individualization. Personalization provides for some basic characteristic to be printed in common on all items. This might be, for example, ink color, type style, or global content such as text or illustrations. The next level of personalization modifies certain features contained in the first level. This might include that parts of the global content have a different color, type style or text modifications. These also print in common on all items. This invention adds to existing personalization technologies the individualization level. The first level of individualization provides for content that is uniquely printed on each item. The next level of individualization provides for the automatic substitution of individualization content based on conditions that may exist in any of the other levels. All of these functions take place over a communications link such as the Internet.

At the request of the client system used by a customer, the server extracts individualization data from a database and merges that data with other variable databases maintained on the server and presents the combined data to the client system for display. The customer, by interacting with the server maintained database, can preview each displayed item. The customer can elect to print samples of the final product locally using a printing device attached to the client system. When the customer is ready, they will elect to print on a paper stock maintained on the printing device at the server system or on the client system if the customer has the required stock and a suitable printer.

This embodiment, when treated as a whole, may comprise an order, may be part of an order system, or may be used in a multiplicity of sub-orders forming part of a complete order. The order may or may not be part of commerce or ecommerce.

The benefits of the individualized printing system of this invention are substantial. First, the customer can order an exact quantity as opposed to fixed quantities often dictated by the fixed plate cost required by printing presses. In the case of wedding or social invitations for example, customers are forced to order a minimum quantity of 25 items so that the cost of the plate is amortized immediately. In addition, if the customer needed only 27 invitations, it is common practice to require ordering in blocks of 25. Thus, the customer is forced to order 50. The customer has all the powerful features of the server-based printing system including, but not limited to stock selection and font inventory. Waste is minimized or eliminated. Time consuming plate making and hazardous materials are not used. Finally, the customer benefits from the added value that the individualized database can be applied to a multiplicity of additional paper products. Wedding invitations are, for example, printed with each guest name as part of the wording (individualization), but the server-controlled printer can also print the fully addressed envelopes, individualized respond cards, and individualized place cards. This invention provides for subsequent printing requirements and features that may change based on conditions that may change as a result of prior print activity. As in the example of wedding invitations, after respond cards are received and a count of guests attending is made, place cards can be ordered in an exact quantity. In sum, there are processes that use the World Wide Web to produce identical printed items, but not unique ones; and there are processes that produce unique printed items but do not use the World Wide Web to do so. This invention is new and novel in that it uses the World Wide Web to provide unique printing for the highest degree of individualization achievable for each printed item.

### BRIEF DESCRIPTION OF THE SEVERAL VIEWS OF THE DRAWING

FIG. 1 is a block diagram of the preferred embodiment.

FIG. 2 is a flow diagram showing a method for template selection.

FIGS. 3(a) and 3(b) illustrate templates that serve as the basis for web page data entry forms for the entry of non-variable (fixed) data, personalization variables, and individualization variables.

FIG. 4 is a flow diagram showing a method for testing for conditional variables and attribute variables.

FIG. 5 is a schematic view of a typical form for the data collection of individualization variables.

FIG. 6 is a flow diagram illustrating a method for printing in either of two locations.

### DETAILED DESCRIPTION OF THE INVENTION

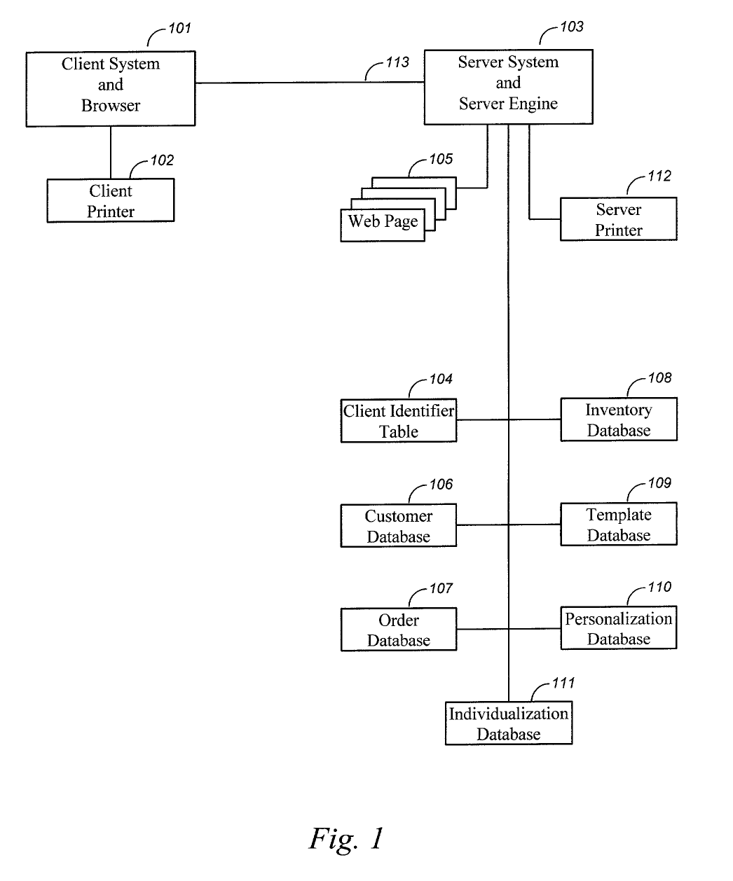

FIG. 1 is a block diagram illustrating the present invention. The embodiment supports individualized printing over the Internet using the World Wide Web with a printing device located on the server system and, optionally, the client system. The client system 101 contains a browser and includes an optional printer 102. The printer may be a laser printer, an ink-jet printer, or any printer capable of printing uniquely different output in each print operation. The server system 103 includes a server engine, client identifier table 104, an array of forms or web pages 105, customer database 106, order database 107, inventory database 108, template database 109, personalization database 110, individualization database 111, and a printer 112. The server engine receives HTTP requests to access web pages identified by URLs and provides the web pages 105 to the client system 101 via the communications network 113. When the client system 101 makes a request, the server system 103 presents a web page 105 to the client system browser. This web page 105 is a data entry form which requests customer information, e.g., name, address, credit card, and so on. The customer also provides a unique identifier such as a “user name” and “password” so that the server system can recognize the customer at a later time or date without repeated use of a data entry form. When the customer completes the data entry form and presses a button on that form, the server system receives the data and stores the information in the client identifier table 104 and is used as a pointer to the customer database 106 and the order database 107. Web pages for the entry of customer information are in common use throughout the Internet and their design and implementation are well known to those skilled in the art.

The various databases shown in FIG. 1 can be combined into one database or can be constructed as separate databases. Any number of databases can be added. For example, if the system were used in an ecommerce application, a product-pricing database would be included. Or, a product-pricing table might be part of one database. Similarly, all of the ‘databases’ of FIG. 1 could instead be tables as parts of one database. The specific design of a database, database tables, indices, pointers, fields, records, and links among tables are easily recognized by those skilled in the art.

The customer interacts with the server system to select an individualization item to be printed from the inventory database 108. In one example, the inventory database 108 might contain product numbers for paper stock that contain different designs and of different sizes. Or the inventory database 108 might contain a tabulation of types of products, for example, golf balls, coffee mugs, paper stock, and so on. If the customer chose coffee mugs, the logic within the database would then point to a table that stored the inventory of all coffee mugs. The customer would then choose a style, type, or coffee mug color.

To implement the process of showing the customer the inventory stored by the inventory database 108, the server system 103 receives a request from the client system 101. The server system ‘knows’ that this is a request for the inventory because this is included in the design of a web page 105. The current web page displayed on the client system 101 simply had a button labeled “Show Product Inventory”. The design, layout, colors, or any other features of web pages 105 is well known to those skilled in the art of web page design. The server system 103 in response to the request sends the client system 101 a new form that generally could be one of two basic designs. One design would show a consecutive listing, preferably pictures, of all the types and colors of coffee mugs in the inventory. An alternative design might show the first coffee mug with buttons such as “Next” and “Previous” on the form. It should be obvious therefore that the specific design of the form chosen by the web page designer has some bearing on the size or quantity of the coffee mug pictures. The form might also contain a statement such as “Select your desired Coffee Mug by clicking a picture.”

Once the customer chooses the type or style of product, they would be presented with an array of templates from the template database 109. Again, as with any database, the template database 109 is linked or pointed to based on the item selected from the inventory database 108. The selected template can contain a multiplicity of types of fixed data, personalization data, and individualization data. Consider that the customer has chosen a coffee mug. Appropriate templates for coffee mugs might depict various places on the mug to include a corporate logo or photograph along with various options on where to print a company name with or without a company motto. Up to this point, this invention has depicted the personalization process that is commonly available. Next, FIG. 1 shows how individualization is achieved.

Say the array of templates presented to the customer from the template database 109 contained variables such as “employee photograph”, “employee name”, and “employee title” in addition to “company logo”, “company name”, and “company motto”. One type of data the customer provides modifies the template content and is repeated on each item to be printed. That would be all the “company” data and this is an example of personalization data. A second type of data the customer provides modifies the template content and is printed uniquely on each individualized item. That would be all the “employee” data and this is an example of individualization data. The template might also include fixed data that would be printed on all items. One example of fixed data is “Copyright” followed by a personalization variable “company name”. Other types of data within the template database 109 might consist of conditional branches which alter the format or content of the template based on the data that is associated with other variables within the template. The variable data required for insertion into the template, is stored on the server system 103 within the personalization database 110 and the individualization database 111. Personalization data is indicia that are repeated, for example, company name, on each printed item. Individualization data is indicia that is unique, for example, employee name, also printed on each item. Note that the printed product resulting from the application of the indicia all contain the company name. The printed product is thus “personalized” with those indicia. However, each printed product also has each employees' name resulting in a printed product is uniquely individualized. This invention produces a printed product of say, ten coffee mugs, each having the company name, but each distinctly different since each mug has a separate employee name. The resulting printing process consists of one order for ten coffee mugs, not ten separate orders.

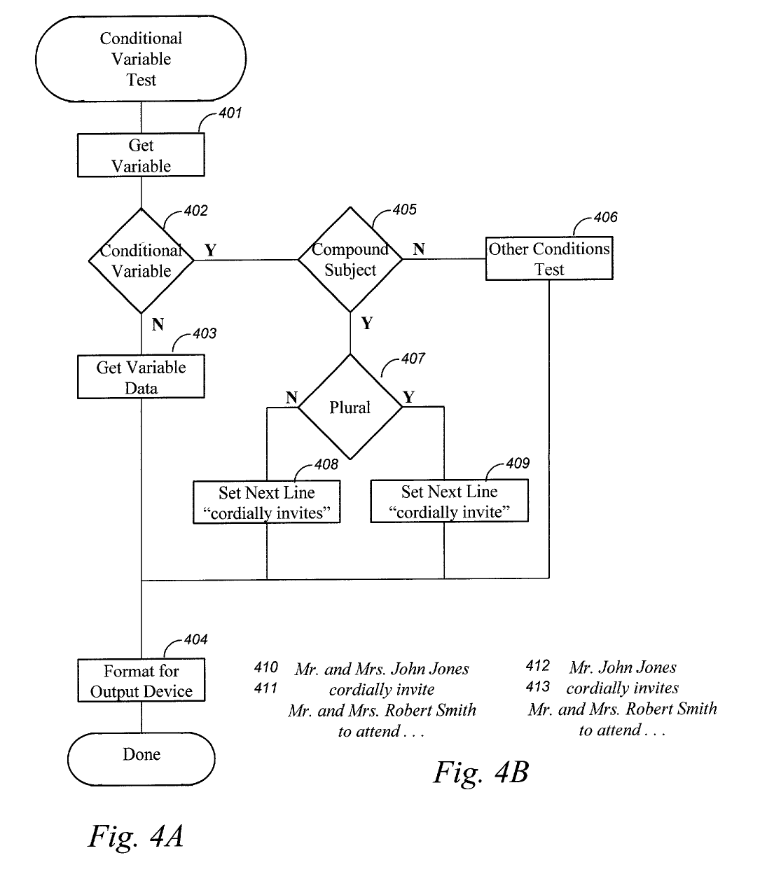

This invention extends the printing of individualized indicia to an addition level by incorporating “conditional variables” into the database. These conditional variables are used to add other features to the printed indicia. For example, the individualization database 111 could contain a variable “employee title”. Any employee who has “programmer” in their title has their name printed in red while any employee who has “vice president” in their title has their name printed in blue. The logic for the implementation of a conditional variable is shown later in FIG. 4A. The logic applies to either the personalization database or the individualization database and furthermore, a conditional variable in one database can be used to effect or modify selected indicia in the other database.

When the customer selects a specific template, the server system 103 sends a new form to the client system 101 that displays the fields for personalization data entry (company data), individualization data entry (employee data), and color-title options dictated by the conditional variable linked to employee title.

In order to enter the data on the form, the displayed web page 105 might show both sides of the coffee mug where one side is the company side and the other is the employee side. It should be obvious that any data the customer enters on the company side stays constant while any data the customer enters on the employee varies with each mug to be printed. Thus, the displayed web page or form might have buttons labeled “Next Employee” and “Previous Employee”. Each time the customer presses one of these two buttons, the client system 101 sends the server system 103 the content of the form along with the status of the button pressed. The server system 103 saves the data in the individualization database 111. If the customer had entered or changed the company data, the server system 103 would have stored the data in the personalization database 110. The server system 103 also responds, based on which button was pressed, with a form reflecting the data appropriate for that button. A different embodiment of this form would not require the two buttons used to select next or previous employee. Instead, the form could have a large data entry box where the user could type employee names while remaining on the same form. In the first case, the form and data is sent over the communications link 113 each time a button is pressed. In the second case, the form and data is sent only once when the user has entered all the employee names. Such form design variations might be based on the bandwidth of the communications link 113 or the user interface features of data entry forms and are well known to those skilled in the art.

Another button on the form displayed on the client system 101 could be used to indicate that the customer has completed the data entry for all the employees. When the server system receives this request, one possible response is to send the client system 101 a summary of the order. This includes, at a minimum, a count of the number of individualized items to be printed and, if required, the cost for the printing. Or for example, the logic in a properly designed server system 103, might examine all of the data supplied by the customer to determine if any of the data is too wide to be printed. For example, the server system 103 responds to the client system 101 with a form showing that the text of a specific individualization datum will not fit within the allowed print area. The logic for this might be part of the template database 109 which contains print area limits which are tested prior to completing the order.

Prior to initiating the printing process, the customer may wish to review the appearance and content of each individualized item. The client system 101 makes a request to the server system 103 to read the item selected from the template database 109 and to merge the two-part data from the personalization database 110 and the individualization database 111 for the first individualized item. The merged data is formatted for display on the client system 101 along with buttons, which permit the customer to step through each item for review. The customer may, at any time, elect to edit or change any feature. This includes but is not limited to the choice of the inventory item from the inventory database 108 and the template item from the template database 109. When the customer elects to make such changes, the client system 101 sends the request to the server system 103 where the appropriate databases are updated to record the changes. To those skilled in the art, this process of updating a database is well known.

When the customer is satisfied with each individualized item, the customer can elect to print a “sample” copy on the optional printer 102 connected to the client system. If the customer has a suitable printing device and an inventory of stock or objects to be printed, the uniquely individualized product may be printed on the optional printer 102

When the customer elects to complete the order, the customer would utilize the inventory of stock or objects collocated with the server system 103. The customer could make a request to the server system to print either a sample of a personalized item that could be delivered for approval or, if desired, the complete set of individualized items comprising the order on the server system printer 111. Depending on the state of the printer 111 or the individualized item stock in inventory, the printing process could begin immediately or could be postponed to a later time or date as necessary. The server system 103 would send a response to the client system 101 to indicate when the individualization printing process will be initiated or completed. And, as an additional feature or typical ecommerce transactions, the server system 103 would inform the client system 101 with a printing date or product delivery date and printing costs and any optional shipping costs.

To further illustrate or extend the functionality of such a system, if the customer was a regular customer of the coffee mug imprinting company, the printing might only print coffee mugs for new employees and then might send an invoice to the customer. On the other hand, if the system were used by consumers at random for one-time orders, the system might present a credit card form to the consumer prior to printing. Normal ecommerce methods would use any number of credit card transaction approval systems to clear the order prior to printing. Business to customer ordering methods based on either on time or repeating customers are commonplace.

The customer interacts with the template and those forms that are the web pages 105 necessary to solicit the variables required by the template sent by the server system 103 to the client system 101. This invention also permits the customer to create his own template on the client system 101 but under control of the server system 103. This might be a general template with items that can be dragged with a mouse or moved by selection with keyboard arrows. These options are all at the disposal of web page designers and are well known to those skilled in the art.

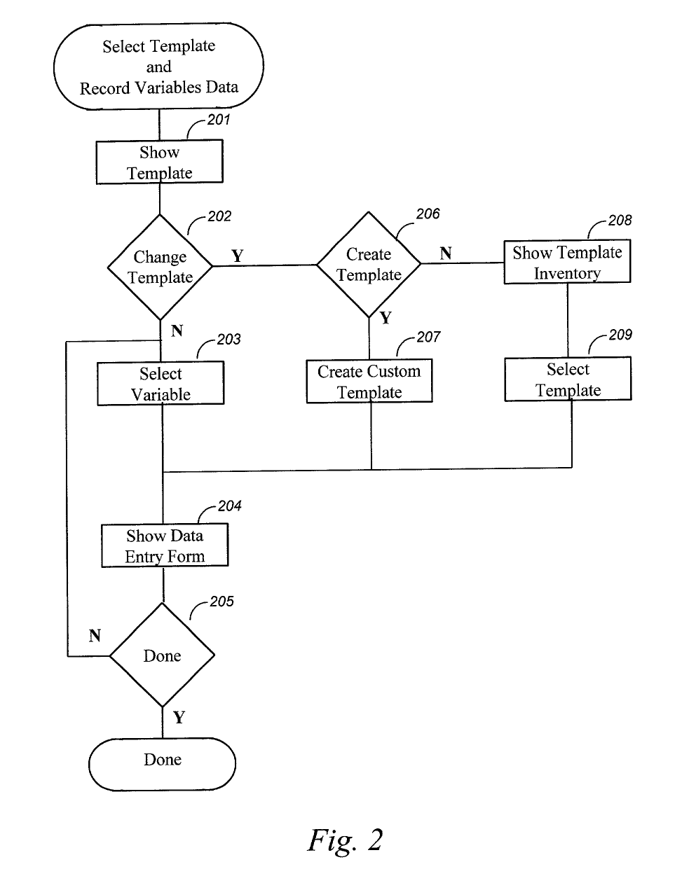

FIG. 2 is a flow diagram of a routine that records individualized imprinting data using a template of variables. When a customer is identified as an existing customer, step 201 retrieves the customer's chosen template and it is sent to the client system for display. The displayed form includes a button permitting the customer to change the template selection as indicated in step 202. If the customer continues with the current template, step 203 indicates that the customer can select one of the variables stored in the template for editing and sends the appropriate form, step 204, to the client system. That form, might include buttons allowing the customer to select records for editing or to add records. Another button in step 205 tests to see if the customer is finished with the current variable. If not, the customer can select another variable in step 203, otherwise the editing session is complete.

Step 202 indicates that even though the customer has selected an existing template, it can be changed and such a re-selection would not affect any of the variables or the data associated with those variables since the logic of the design of the templates is very similar. They may use the same variable names and data types. If a new template used a different set of variables, the customer would be advised of that difference. Step 206 is used to offer the customer the opportunity to create his own template or to preview the entire template inventory. In step 207, a form is sent to the client system, which permits the customer to design his own template. One reason for this opportunity is that the customer may have special needs that the inventory of server system templates does not accommodate. The form that is displayed might include all possible variables, conditions, and attributes. The customer could rearrange these and incorporate their own fixed text to form a new template. The customer, when finished would proceed to step 204 where the first data entry is provided.

Based on step 206, the customer might elect to select one of the existing templates. Step 208 sends the client system a form with all the templates. One design of that form would be to permit the customer to simply click on a desired template to select it. Again, once chosen, the customer would be given the opportunity to enter data for a template variable in step 204.

Whether the customer creates a unique template or uses an existing template is not important. However, the template itself is a significant part of the individualization process since it contains text or images common to all individualized items and contains fields or variables for the entry of data, which will be printed uniquely on each printed item. It also contains conditions and attributes which vary other printing features on each printed item. Thus the template is used to present an array of different data entry forms to the customer.

In step 204, the customer is presented with a data entry form based on requirements established by the template. If the template requires a multiplicity of data entry forms, a menu of forms would be provided instead. The form presented in step 204 consists of one or more fields wherein the customer enters suitable data. Buttons on that form are used to save the data, move among records of data, or to indicate that the data entry is complete in step 205. The technology to enter data on data entry forms, move among data records, and to save or retrieve data is familiar to those skilled in the art.

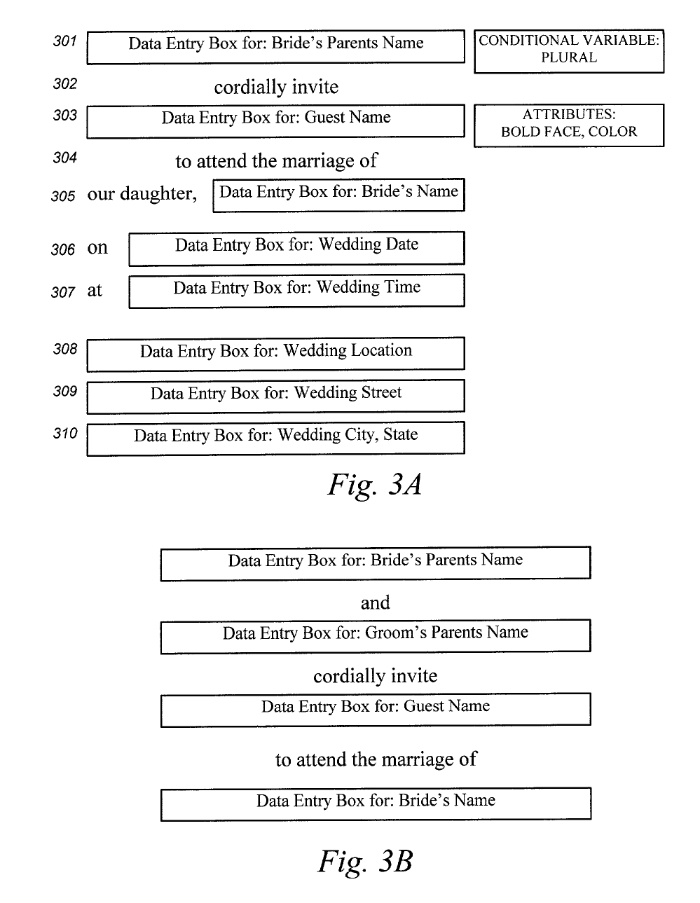

FIGS. 3A and B illustrate two examples of templates containing a multiplicity of variables and fixed indicia. In practice, the templates are translated into forms that are web pages for transmission to the client system by the server system. In contrast with the previous example using coffee mugs, these templates are examples of wedding invitations. This shows that the invention allows for any number of implementations. It also demonstrates how templates can contain logical elements and attributes that affect the printed product in a manner hidden to the customer or selectable by the customer.

FIG. 3A is an example of the beginning of one style of wedding invitation wording. Lines 301, 303, 305, 306, 307, 308, 309, and 310 show where the customer can enter data. Lines 302 and 304 illustrate text that the customer cannot change. Lines 305, 306, and 307 are arranged to show that text outside the data entry box is text that the customer cannot change but associated with that text and to be printed on the same line is data variables that can be entered by the customer. The web page designer would most likely layout the form in a similar manner since it is intuitive and closely represents how the printed product will appear.

FIG. 3A also shows that a template may be designed to contain conditional variables or attributes as illustrated by the right side of lines 301 and 303. Neither figure illustrates how the form could be designed as a web page since this is well known to those skilled in the art. It is clear that in FIG. 3A, only the bride's parents are giving the bride away. Compare this to FIG. 3B where both sets of parents are hosting the event and are therefore included on the invitation wording. Thus FIG. 3B is a simple example of one of many variations of data entry forms. In this case, when both parents are giving the bride away, as might be an option on some other form, the contents of FIG. 3B replace lines 301, 302, 303, 304, and 305 of FIG. 3A.

In the invitation wording of FIG. 3A, lines 301, 305, 306, 307, 308, 309, and 310 are all data variables that are common to the wedding event. These do not change on successively printed items. These are personalization datum that would be entered into the personalization database 110 of FIG. 1. One implementation of a web page which might call for the entry of data suitable for this social event might be called “Wedding Data Entry Form” and that web page would solicit the Brides Name, Parents Name, Wedding Date and Time, and so on. Creative web page design might call for a calendar display so that the customer could simply click the calendar to select the wedding date. The software code would accept the click and translate the date function common in software code to the appropriate script automatically. This coding technique is well know to those skilled in the art and is simply part of good web page or software design.

In FIG. 3A, line 303, the Guest Name variable, will change on each successive printed invitation and clearly shows how this invention is used in the process of individualization. The Guest Name variable, line 303, is used as part of the wording on the wedding invitation, each being unique, is stored in the individualization database 111 of FIG. 1A. An order for wedding invitations is usually supplied with matching envelopes. That being the case, a likely form for entering a guest name would also include address data. That data might be stored in a guest name/address portion of the individualization database. When it is desired to print invitations, wedding event data from one part of the individualization database is merged with guest name data from another part of the individualization database along with other fixed data from the underlying template. A similar activity would ensue when printing envelopes. This invention accounts for this multiplicity of uses of the individualization database.

The option of using separate forms or entering the data on the immediate form is part of the design of the template. The template then, directs the server system to pre-designed forms that can be sent to the client system. In an implementation of this invention when the product is wedding invitations and envelopes, a logical sequence of forms presented to the customer might be “Select Paper Design”, followed by “Enter Event Data”, followed by “Select a Wording”, ending with “Enter Guest Names and Addresses.” If this sequence is used, when the customer is selecting wordings, all of the event data previously entered can be merged into each wording example to provide the customer with wording selections that already include their event. The remaining variable, guest name of line 303, might be temporarily displayed as “Guest Name Goes Here.”

FIG. 3A shows in line 303 that the customer has a choice to make the guest name print in a normal font style like the rest of the invitation or to make it stand out by printing it in bold face style and/or in a selected color. Such typesetting features are easily incorporated in the database associated with wording selections. When it is desired to have such an option, its functionality is stored in an appropriate template.

This invention includes an additional element that is related to individualization. FIG. 3A illustrates one example of a template that contains a conditional variable called PLURAL for line 301. This need not be displayed to the customer since the customer need not control this variable. Line 302 is a part of the common text of the template that cannot be changed by the customer. It may need grammatical correction based on the contents of line 301. This correction is required but there is no need to burden the customer with this requirement or to expect that the customer understands that a grammatical correction is required under certain circumstances. An example of the use of this conditional variable is illustrated in FIG. 4.

FIG. 4A is a flow diagram of a routine that implements an example of the processing of a conditional variable, in this case the PLURAL variable discussed in FIG. 3A. A template can include conditions, commonly called conditional statements that cause some parts of what is to be printed to change based on the values contained in certain variables. One way such conditions are tested and executed in software code is through the use of “if-then-else” constructs known to software programmers. FIG. 4B shows two examples of the first part of a wedding invitation wording. One example begins with lines 410 and 410; the second example begins with lines 412 and 413. In the first example, line 410 corresponds to the data entry box of FIG. 3A, line 301. This is the data entry box for the “Bride's Parents Name” variable, and as the italicized text of FIG. 4B shows, it is two people or plural. Line 411 shows the grammatically correct “cordially invite” which should follow. FIG. 4B also shows an example where the “Bride's Parents Name” variable of line 412 is only one person and shows the grammatically correct line 413 “cordially invites” which should follow.

This invention, using such conditional variables in the design of the forms and both the personalization database and the individualization database, allows for conditional variables to affect the indicia that can be displayed or printed from either database. For example, a conditional variable in the personalization database might be used to affect or modify a record in the individualization database prior to display or printing.

Whether for display or printing, FIG. 4A, step 401 gets the actual data for testing. In this case the actual data is either FIG. 4B, line 410 or line 412. FIG. 4A, step 402 tests for a “conditional type variable”. If the result of the test in step 402 indicates that the variable is of the conditional type, then step 405 tests for the first in a series of conditional type variables. In this case, the test is a ‘compound subject’ grammar test. Step 406 shows that any series of similar routines could be included to test for other types of conditional variables.

If the variable tested in step 405 is a “compound subject” variable test, then step 407 tests the value of the current variable. It might do this by searching the variable for the text “and”. Finding an “and” means that it is a compound subject meeting the PLURAL test and, in step 409, makes certain that the next printable line of the template is “cordially invite”. Or, if the test of step 407 shows that the variable is singular, step 408 substitutes “cordially invites” for the next printable line of the template.

Returning to the test of step 402, if the variable is not a “conditional type variable,” step 403 indicates that the current variable has no conditions so use the actual data variable. In practice, other types of tests could be made here. One example would be an attributes test for bold face type. Step 404 formats the variable for the output device, a printer or display device. Formatting in this example would include setting the font, font size, color, and print coordinates for the line of text.

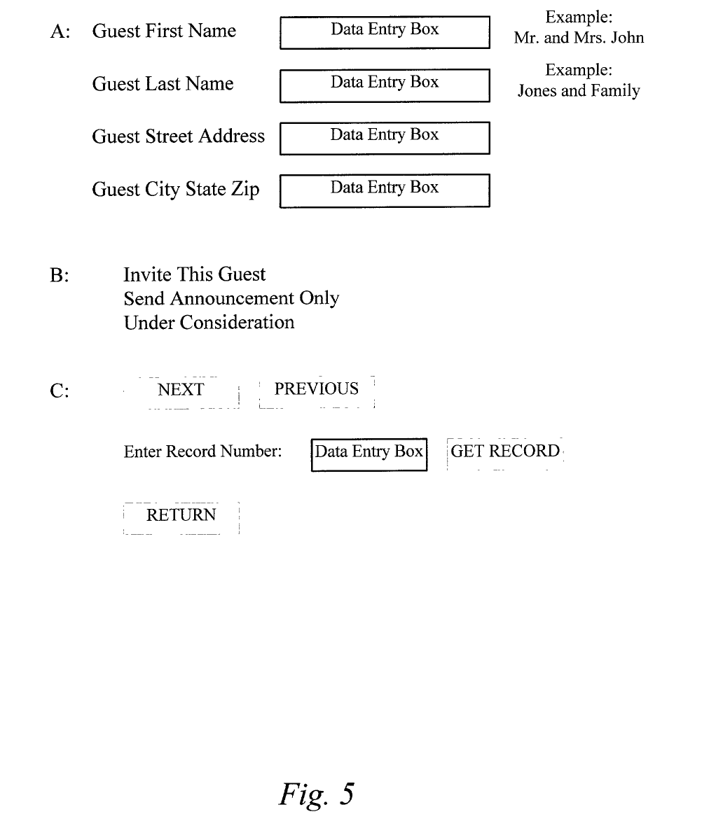

FIG. 5 illustrates an individualization data entry mechanism in one embodiment. When collecting information from a user, a web page is generated on the server system and sent to the client system. The layout of the web page is designed to facilitate data entry by the user in an easily understood manner. FIG. 5 illustrates an outline format of a sample form to be filled in. The sample form contains various sections identified by letters A, B, and C. In particular, the illustrated example shows a form for collecting names and addresses such as might be used for a guest list. Section A shows data entry boxes for name and address data along with an example of how the customer should enter this data.

Section B of FIG. 5 permits the customer to assign certain attributes associated with the data. In the depicted case, the three text lines are made part of ‘radio buttons’ in common use in the design of web pages. Radio buttons, like the push buttons on car radios permit selection of only one item of a group of items. This is well known to both software programmers and web page designers. In the section B example, only one of the three options is possible for a given guest. When this form is present, the ‘Invite This Guest’ radio button might be the default condition.

The attributes shown as ‘radio buttons’ in FIG. 5, section B might be used to differentiate the printing of invitation envelopes versus announcement envelopes. Or, as in the case of wedding invitations, two different templates might be used. One template contains an invitation wording; another, an announcement wording. In this case, should the customer press select the “Send Announcements Only” option for at least one guest, logic built into the template would advise the customer that he should also select an additional template worded specifically for announcements.

Section C of FIG. 5 shows form buttons that control access to a particular record. Specifically, this example form is used to collect guest names for the personalized printing of that guest name on each wedding invitation. In this case, the section A “first name” and “last name” variables are merged together with a space separator and are substituted as variable in the invitation wording. However, this same data along with the address are used when printing envelopes. Separating the first and last names permits logic associated with the database storing guest name and address data to sort the guest list based on the last name. This might be useful if the customer wishes to have an alphabetically ordered printout of the guest list on the printer attached to the client system. The printed guest list sent to the client system is not a printed product of this invention but simply a customer report printed on ordinary paper.

The buttons shown in Section C are used to select the record for data entry or editing. In this case, the customer has the option of pressing the NEXT or PREVIOUS button to retrieve and display the appropriate adjacent record within and retrieved from the individualization database. When so pressed, the currently displayed data on the client system is sent to the server system along with an indication of the button that was pressed. The client system would record the data as a new record if it were such or overwrite a current record with this data accordingly. Section C also contains a GET button and data entry box that permits the customer to rapidly retrieve any selected record. For example, if the customer had printed a copy of their guest list previously, they could enter a guest record number shown on that list by typing that number in the data entry box and pressing a Get Record button. FIG. 5, section C shows a RETURN button that is used to indicate that the customer is finished with this data entry form and wishes to return to a menu of other activities, e.g., to access a different form or to initiate the individualization printing process.

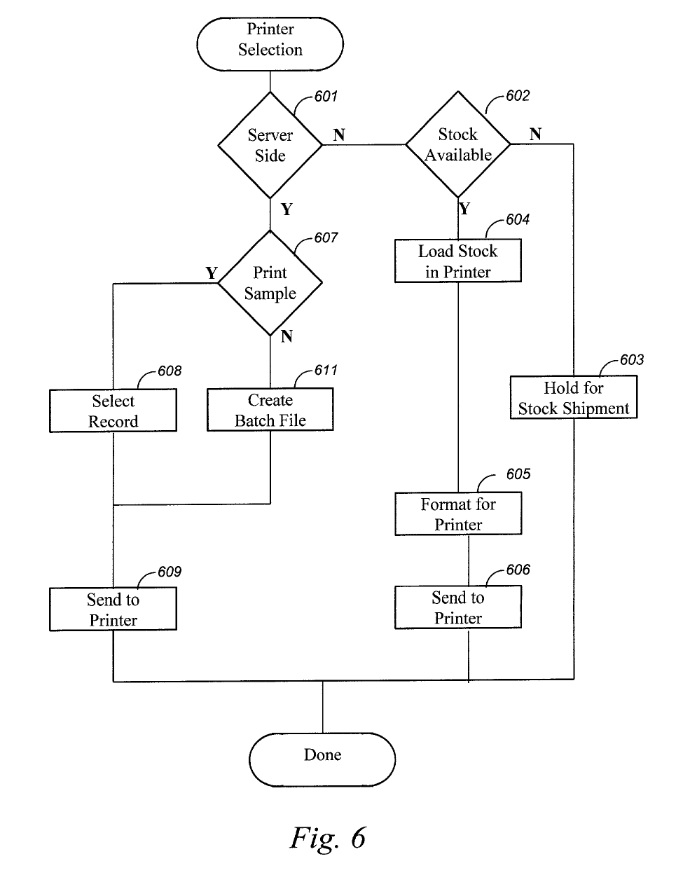

FIG. 6 is a flow diagram of a routine that implements printing on either the server side or the client side. Server side printing includes printing a sample for delivery to the customer for approval or for printing the complete order. Client side printing serves to print reports or a plain paper replica of the printed product, or when the client side has an inventory of stock or objects on which the indicia will be printed, printing may be made on the client side. The server system sends a form to the client system requesting the customer to advise if the print request is for the server side or client side. Based on the customer response, step 601 branches accordingly. If the customer desires, they can print a single sample of one of the uniquely individualized products as a picture of that product on plain paper, print a sample of their entire order, or print the complete order if they have the necessary stock or objects and a suitable printer. If, as a result of step 607, a sample is desired, step 608 might select a specific database record. Step 607 would then send a request to the server system for that record and the server system would respond back to the client system with the appropriate record. At that point, the customer could press the print button on his browser in step 609 and cause the print operation to occur. If the customer desired a sample of all records or desired to print on the stock or objects, step 607 would create a batch file, step 611, and format the data on one or more web pages for subsequent printing on the client system.

If the customer is ready for the final order to be printed on the server side, step 607 branches to test for stock availability in step 602. If the stock is not available, step 603 simply places the order on hold until stock becomes available. When the stock is on-hand, step 604 might request that someone physically place the stock into the printing apparatus and in step 605, format the data based on template variables and initiate printing in step 606.

I claim:

1. A method of collecting and combining a plurality of unique individualized datum under control of a client system,
a) on forms presented to the client system from the server system over a communications link,
b) recording records of unique individualized data on the server system database; and
c) displaying, editing, and combining that data in a multiplicity of ways; and
d) printing that data such that each printed item is unique.

2. The method of claim 1 wherein the raw printable stock is an inventory of the server system 2. The client system of claim 1 wherein the display component on the client system is a browser.

3. The method of claim 1 wherein the displaying includes displaying an HTML document provided by the server system to the client system.

4. The method of claim 1 wherein the displaying and printing of the unique item includes adding non-unique data previously stored on the server system.

5. The method of claim 1 wherein the product is two or more items wherein the content printed on the items is unique from item to item.

6. The method of claim 1 wherein the unique data is supplied by the client system; and wherein that unique data is not a pointer to or makes reference to non-unique data stored on the server system.

7. The method of claim 1 wherein the print quantity is directly related to the number of records of unique data in the server system database.

8. The method of claim 1 wherein the unique data can be applied to different physical sizes and shapes of printed items.

9. The method of claim 1 wherein the unique data can be modified by other data which may either be constant or unique.

10. The method of claim 1 wherein typographical attributes of the printed data can vary based on criteria specified by choices on forms displayed by the client system.

11. The method of claim 1 wherein the server system for generating the printing uses a data storage medium storing information for a plurality of users; and
a receiving component for receiving requests to collect, display, and print items, a request including an indication of one of the plurality of users.

12. The method of claim 1 wherein the client system can request the server system to print selected items or all items at different times.

13. The method of claim 1 wherein the items to be printed are related and have associated dependencies.

14. The method of claim 1 wherein content, attributes, and quantities of subsequently printed items are dependent on either user changes or decisions or variables associated with previously printed items.

15. The method of claim 1 wherein content, attributes, and quantities of subsequently printed items are dependent on variables of previously printed items.

16. The method of claim 1 wherein the server system can retrieve unique data from the client system when the client system is not connected to the server system for the purpose of sending the collected information to the server system at a time determined by the requester for the purpose of reducing costs associated with maintaining a connection to the server system.

17. The method of claim 16 wherein the server system can send to the client system a standalone executable software element that permits the client system to collect and change the unique data without connection to the server system.

18. The client system of claim 17 wherein the data entry and display component is a stand-alone executable software element.

19. The method of claim 16 wherein the client system can connect or reconnect to the server system for the purpose of sending to the server system unique data that was collected or changed while the client system was not connected to the server system.

20. The method of claim 16 wherein the content of the unique items can only be modified by or changed by content residing solely on the server system prior to printing.

21. The method of claim 20 wherein the client system and server system communicate via the Internet.
